(19) United States
(12) Patent Application Publication
(10) Pub. No.: US 2018/0019608 A1
(43) Pub. Date: Jan. 18, 2018

(54) POWER GENERATOR SYSTEM AND ASSOCIATED METHODS METHODS OF USE AND MANUFACTURE

(71) Applicant: FAA, LLC, Merritt Island, FL (US)

(72) Inventor: Dennis Foldesi, Merritt Island, FL (US)

(21) Appl. No.: 15/547,165

(22) PCT Filed: Jan. 28, 2016
(86) PCT No.: PCT/US16/15261

§ 371 Date: Jul. 28, 2017

Related U.S. Application Data
(60) Provisional application No. 62/109,315, filed on Jan. 29, 2015.

(51) Int. Cl. H02J 7/00

(52) U.S. Cl. CPC H02J 7/0068; H02J 7/007

(57) ABSTRACT

Various embodiments of a power generator system are disclosed herein. In one embodiment, a power generator system includes a battery power source, an inverter-charger and a transfer switch for providing backup power to a home during a power outage. House current can be used to charge the battery power source when available. The power generator system can also include a generator configured to charge the battery power source when house current from the home is unavailable. The battery power source can be housed within a weather-proof enclosure.

### PRIORITY CLAIM

This application is a 371 U.S. National Stage Application of International PCT Application No. PCT/US16/15261 filed on Jan. 28, 2016, which claims priority to U.S. Provisional application Ser. No. 62/109,315, filed Jan. 29, 2015, the entire contents of each of which are incorporated herein by reference and relied upon.

### TECHNICAL FIELD

The present technology relates generally to power generator systems and, more particularly, to battery-powered backup generator systems for providing power during power outages.

### BACKGROUND

Various types of generators are known for providing emergency power for a house during power outages. Typically, a whole house generator is used to power the entire house (e.g., all the electrical systems and devices of the home) during a power failure. The energy or power required to start a motor can be as much as three times the energy or power required to run the motor. Therefore, a generator for a house is generally of a sufficient size to not only run all the electrical systems and devices (e.g., air conditioners or refrigerators) of the house, but also start, e.g., the motors of such electrical systems and devices.

If a generator is of an inadequate size when an air conditioner starts or restarts (e.g., during a power outage), which can require three motors to start simultaneously (e.g., a compressor, compressor fan, and blower), a generator may be loaded such that it will not produce the proper and/or sufficient voltage and/or frequency. This may lead to motors of other systems and devices (e.g., a refrigerator motor) trying to restart which may further increase a drain on power produced by a generator. This drain (e.g., drop in sufficient voltage and/or frequency) may cause certain sensitive electronics (e.g., of the electrical systems and devices) to be damaged.

Additionally, certain generators (e.g., a 16 KW gasoline, liquid-propane and/or natural gas powered generators running at or about 3,800 RPMs) that can provide sufficient whole house power (e.g., to start and run all the electrical devices and systems) may result in excessive and/or increased pollution and/or noise. In some instances, even if only one device is plugged in (e.g., an alarm clock), a generator must operate at full speed all the time. Accordingly, it would be advantageous to provide a power generator system having reduced pollution and/or noise, reduced total output (e.g., 6 KW versus 16 KW), an improved design, increased service life, and/or improved functionality during power outages.

### BRIEF DESCRIPTION OF THE DRAWINGS

FIG. 1 is a schematic diagram of a power generator system configured in accordance with an embodiment of the present technology.

FIG. 2 is a schematic diagram of the power generator system of FIG. 1 configured in accordance with another embodiment of the present technology.

FIG. 3 is a schematic diagram of the power generator system of FIG. 1 configured in accordance with another embodiment of the present technology.

FIG. 4 is an isometric view illustrating additional details of an enclosure for batteries of a power generator system configured in accordance with an embodiment of the present technology.

FIG. 5 is a schematic diagram of the power generator system of FIG. 1 coupled to electrical loads of a home configured in accordance with an embodiment of the present technology.

FIG. 6 schematically illustrates an example method for operating a power generator system configured in accordance with an embodiment of the present technology.

### DETAILED DESCRIPTION

The present technology describes various embodiments of power generator systems to provide power during power outages, shutdowns, emergencies, and/or in remote, rural, or off-grid locations, for example, where a main or normal power supply (e.g., provided by a utility) is down, unavailable, and/or unreliable. In one embodiment, for example, a power generator system includes a power source or supply (e.g., one or more batteries) other than the power supplied by a utility or other commercial provider, an inverter-charger, a transfer switch and a generator. The power source can provide backup and/or emergency power to a house to run the various electrical systems and devices of the house (e.g., various loads of the house) during a power failure or outage and be recharged as necessary. As described in greater detail below, the power generator system can also include other features to enhance operation, improve functionality, increase efficiency and/or reduce noise and/or pollution. Such features can include, for example, utilizing batteries to power house loads during power outages and controlling the system to provide emergency power only during low power utilization times (e.g., in the evening when the air conditioner is not running) and/or for only shorter periods of time. Another feature can include utilizing a transfer switch to flow house current (e.g., current from a utility grid or commercial provider) when available to an inverter-charger to charge the power source (e.g., batteries) but running a generator when the power is out to charge the power source when necessary. In certain embodiments, all backup power is or configured to be provided by the batteries (e.g., the batteries can have the capacity to produce about 16 KW, or less than or greater than about 16 KW, for short periods of time).

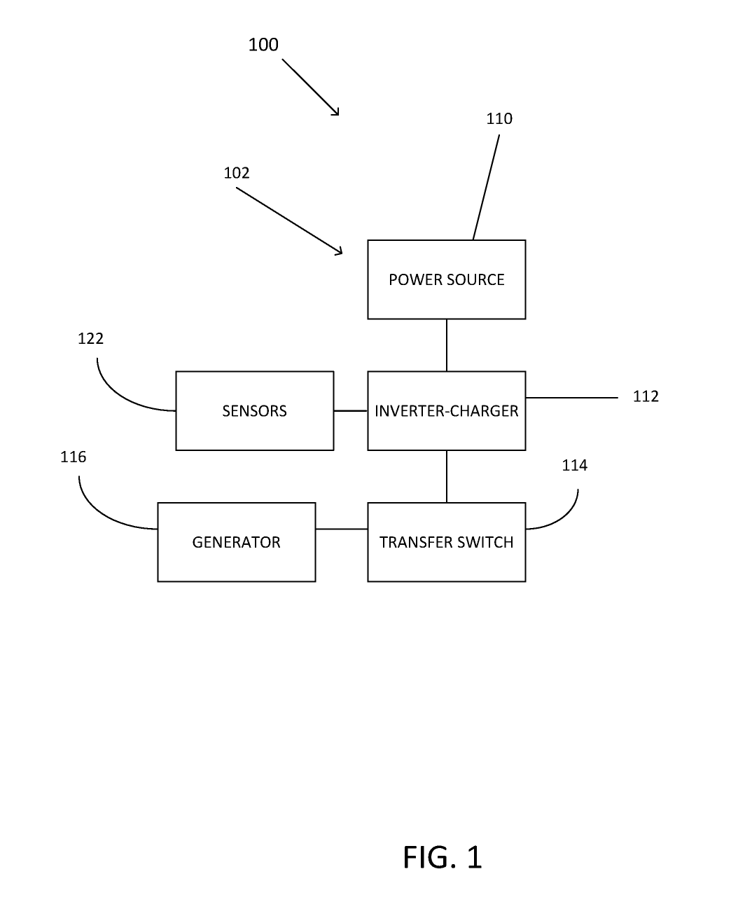

Certain details are set forth in the following description and in FIGS. 1-6 to provide a thorough understanding of various embodiments of the present technology. Other details describing well-known structures and systems often associated with power generator systems, generators, switches, inverters, batteries, sensors, controllers, circuit panels, grids, etc. have not been set forth in the following disclosure to avoid unnecessarily obscuring the description of the various embodiments of the present technology.

Many of the details, dimensions, angles and other features shown in the Figures are merely illustrative of particular embodiments of the present technology. Accordingly, other embodiments can add other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

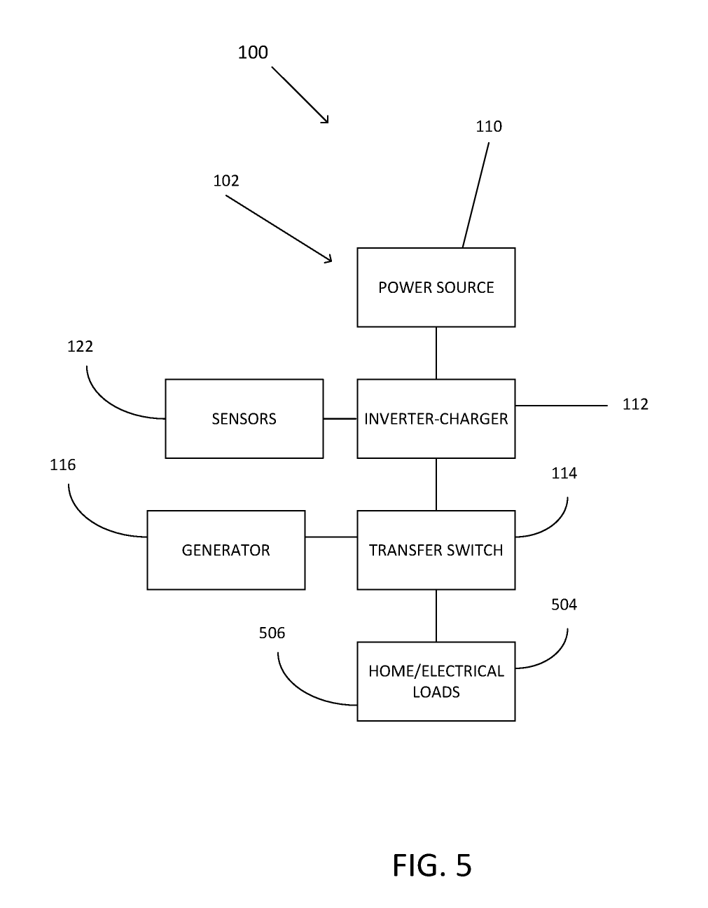

FIG. 1 illustrates a schematic diagram of a power generator system 100 configured in accordance with an embodiment of the present technology. Referring to FIG. 1, in one aspect of this embodiment, the power generator system 100 includes a power source 102 (e.g., one or more batteries 110), an inverter-charger 112, a transfer switch 114 and a generator 116. The power source 102 is configured to supply or supplies power (e.g., backup power). The power source 102 can supply power to electrical loads 504 (e.g., electric devices and systems) of a home 506 during a power outage (e.g., an emergency) and/or in a remote location when power generally supplied by a utility or other commercial provider is unavailable (e.g., off-grid locations) and/or unreliable as described in more detail with reference to FIG. 5. The electrical loads 504 can include, but are not limited to, a refrigerator, heating, ventilation, and air conditioning systems (e.g., HVAC systems), light fixtures, garage doors, elevators, computers, printers, televisions and other types household electrical devices that can be plugged into and/or electrically coupled to an electrical outlet, an electrical panel, and/or a main utility grid, e.g., of the home 506. The electrical loads 504 can also include electrical loads supporting operation of renewable energy systems, recreational vehicles (RVs), mobile homes, camping sites, construction sites, water treatment or other remote locations, office buildings, industrial buildings, hospitals, farms, factories, gas stations, rest stops, schools, and for other emergency or backup applications

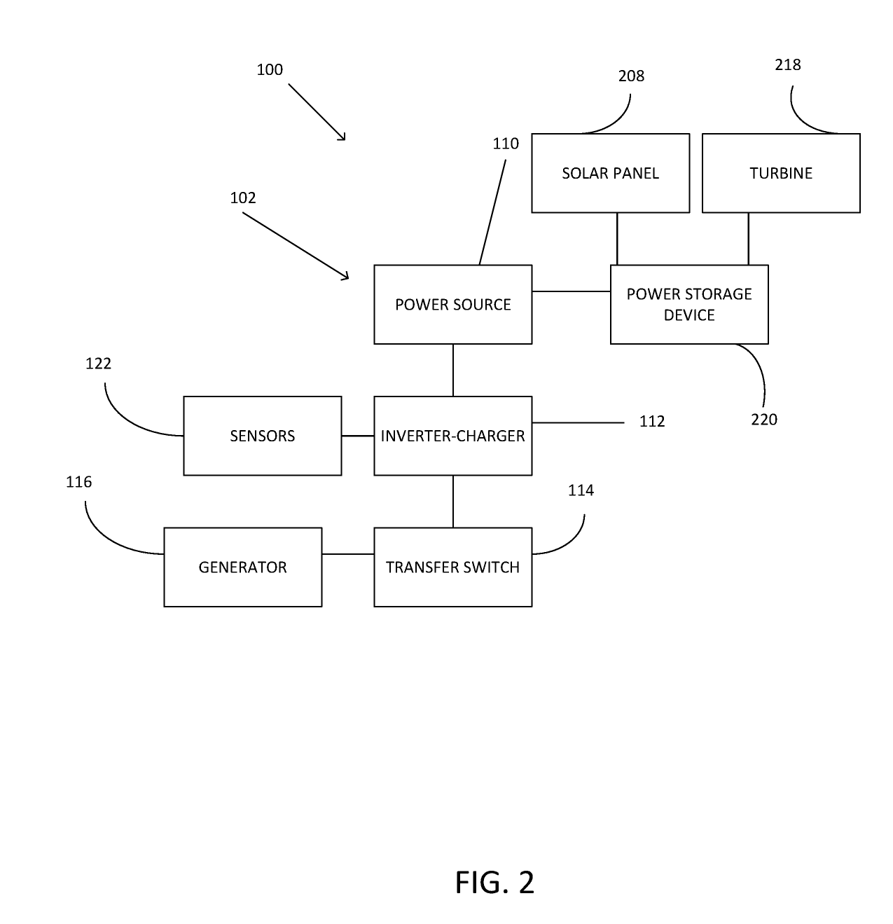

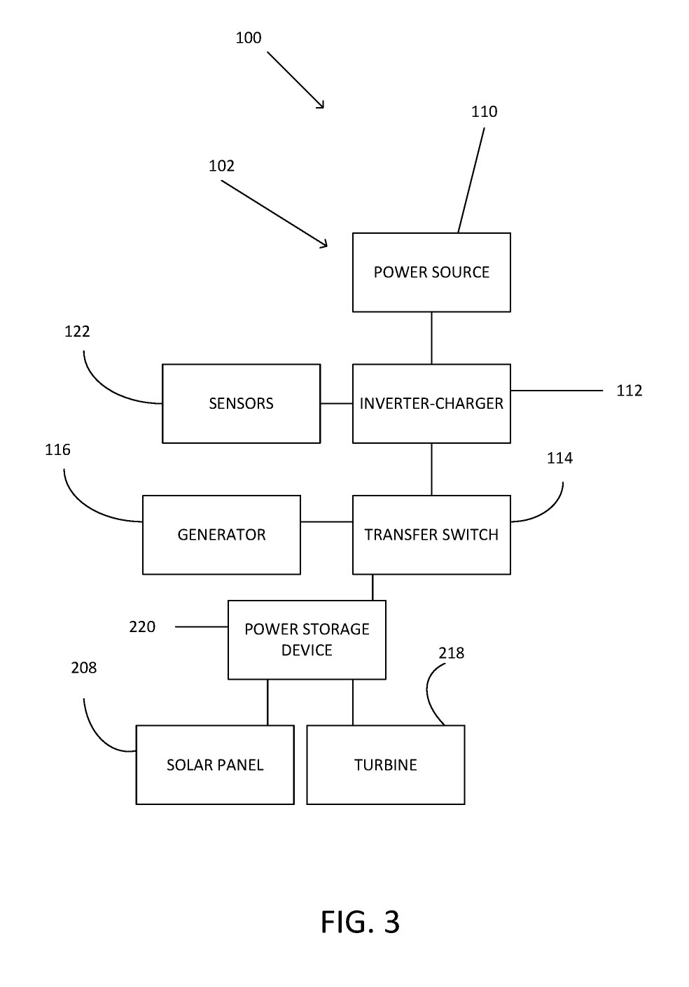

In the illustrated embodiment, the batteries 110 can provide power (e.g., direct current (DC) power) to the electrical loads 504. In other embodiments, the power source 102 can include other types of power sources (e.g., of DC power or alternating current (AC) power) in place of or in addition to or combination with the batteries 110. For example, in some embodiments (e.g., as described in more detail with reference to FIG. 2), the power source 102 can include one or more fuel cells or solar panels 208 and/or turbines 218 (e.g., wind, hydro and/or steam) for powering the electrical loads 504. In some embodiments, the power generated by, e.g., the solar panels 208 and/or turbines 218, can be used to recharge the batteries 110 in addition to or instead of powering the electrical loads 504 as described in more detail with reference to FIG. 3.

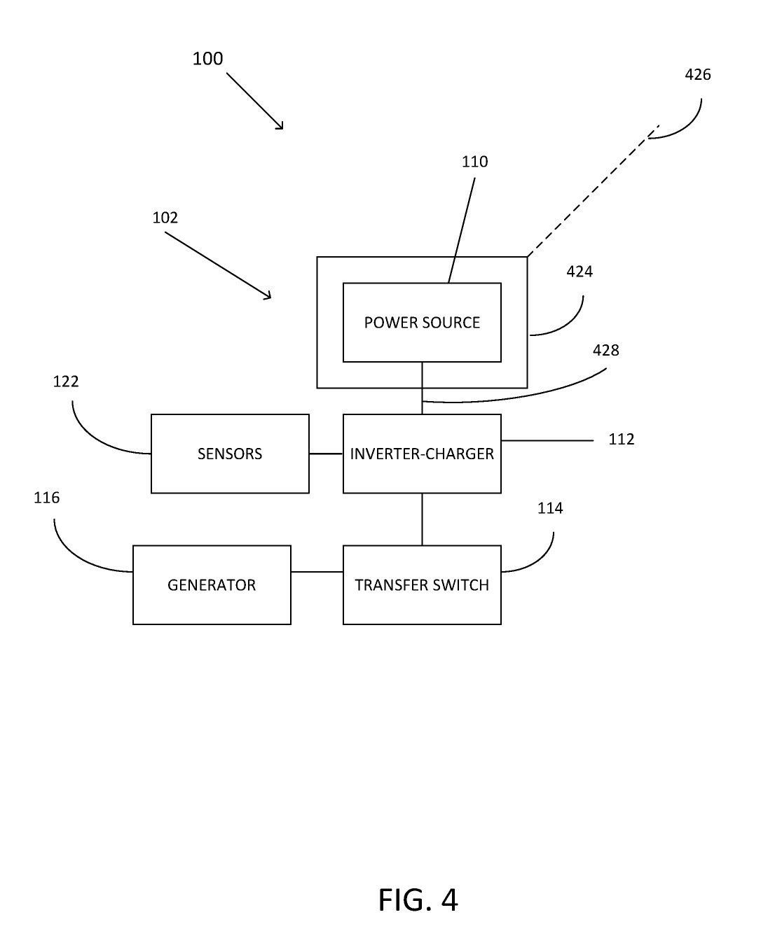

In the illustrated embodiment, one or more of the batteries 110 can be electrically coupled in series. The batteries 110 can include e.g., (4) 12-volt batteries (e.g., car batteries) electrically coupled (e.g., tied) in series to produce a total voltage (e.g., of, 48 volts) to be supplied to the inverter-charger 112. In other embodiments, the power source 102 can include other various types and/or combinations of batteries 110 and/or battery voltage amounts to produce a total voltage as desired for the inverter-charger 112 to convert as described in more detail below. In other embodiments, the batteries 110 can be electrically coupled in series or both series and parallel. In some embodiments, as described in more detail with reference to FIG. 4, the batteries 110 can be sealed within a weather proof enclosure 424 (e.g., a battery box or a weather resistant enclosure).

The inverter-charger 112 can be electrically coupled (e.g., connected) to the power source 102 (e.g., the batteries 110) and is configured to convert or converts the DC power provided by the batteries 110 to AC power to power the electrical loads 504. The inverter-charger 112 can be electrically coupled and/or integrated with the transfer switch 114 and/or the power source 102. For example, in some embodiments, the inverter-charger 112 and the transfer switch 114 and/or the power source 102 can be integrated and/or combined into a single device and/or enclosure. In certain embodiments, the inverter-charger 112 can include an off-the-shelf device (e.g., a Global LF Series 10000 Watt Pure Sine Inverter Charger 48 Volt 220/240 VAC, Model# PICOGLF10KW48V240VS, Tesla Powerwall, etc). Likewise, in some embodiments, the transfer switch 114 can include an off-the-shelf device (e.g., a Generac Transfer Switch). In some embodiments, the inverter-charger 112 and/or the transfer switch 114 can be of other various brands, types, models and/or sizes. In other embodiments, the inverter-charger 112 and/or the transfer switch 114 can be modified or custom fabricated devices.

The inverter-charger 112 can be configured to convert DC power provided by the power source 102 (e.g., batteries 110) into AC power and to charge (e.g., automatically) the batteries 110 (e.g., when the batteries 110 are at low power levels or drained and/or after a set period of time (e.g., of usage, non-usage, etc.) by flowing house current and/or power from another source (e.g., the generator 116) to the batteries 110. As illustrated in FIG. 5, the inverter-charger 112 and transfer switch 114 can be electrically coupled to the home 506 (e.g., via a utility grid, main circuit panel, secondary circuit panel, and/or an electrical outlet) such that house current can be used by the inverter-charger 112 to charge the batteries 110. For example, the transfer switch 114 can be used to flow house current to the inverter-charger 112 to charge the batteries 110 as necessary when house current is available (e.g., during normal operation and/or non-emergencies).

In one aspect of the illustrated embodiment, the inverter-charger 112 and transfer switch 114 can be electrically coupled to the home 506 and the generator 116. When house current is not available (e.g., during a power outage or emergency) and/or unreliable, a supply of current or power can be “switched” via the transfer switch 114 to being provided by the generator 116 from the house current from the home 506 to flow current as needed to the inverter-charger 112 to charge the batteries 110 or other power source 102. When house current is available, the transfer switch 114 can switch to provide current supplied from the generator 116 to the house current from the home 506 to the inverter-charger 112 to charge the batteries 110 or other power source 102. The generator 116 can be an off-the shelf generator (e.g., a 6 KW Generac generator). In other embodiments, the generator 116 can be of any type, model, brand, and/or size of off-the-shelf backup or emergency generator. In some embodiments, the generator 116 can be a modified or custom fabricated generator.

FIG. 5 schematically illustrates the home 506 having the power generator system 100 configured to power the electrical loads 504 in accordance with an embodiment of the present technology. In the illustrated embodiment, the generator 116 is not configured to (e.g., is not adequately sized to) and/or does not provide power to the electrical loads 504 of the home 506. Generally, a 6 KW generator cannot adequately start and continuously run a house that requires, e.g., 6 KW just to run all the electrical loads of the house continuously. For example, if a house requires 6 KW to run all the electrical loads continuously, it generally will require more than 6 KW to start motors of certain devices, e.g., 16 KW. The generator 116 is configured to only charge the batteries 110 or other power source 102 as needed (e.g., when the batteries 100 are drained and/or house current is unavailable). For example, the generator 116 is not configured to or does not directly supply power to the electrical loads 504 of the home 506.

In one aspect of the illustrated embodiment, the generator 116 provided with the power generator system 100 can be sized such that it is inadequate or insufficient to start and run the electrical loads 504 of the home 506 continuously, but adequate to charge the batteries 110 and/or other power source 102 during a power outage. This can result in a reduction in size, noise and/or pollution of the generator 116 required for the home 506 as compared to a generator that is configured to power continuously and start, if necessary, all loads of a home during a power outage, emergency, etc. In other embodiments, the generator 116 can be used to power (e.g., at least partially) the electrical loads 504 in combination with the batteries 110 or other power source 102 and/or if the batteries 110 or other power source 102 are inoperable.

In some embodiments, the power generator system 100 can include one or more sensors 122 (e.g., a sensing system built or integrated into the inverter-charger 112 and/or electrically coupled to the home 506, electrical loads 504, and/or utility grid). The sensors 122 can sense when the batteries 110 or other power source 102 require charging and/or a power outage (e.g., when house current supplied by a utility grid is down). The sensors 122 can signal to the transfer switch 114 to “run” the generator 116 as necessary to charge the batteries 102 or other power source 102. When the power (e.g., house current from a utility grid) is available, the sensors 122 can signal to the transfer switch 114 to flow house current to charge the batteries 110 or other power source 102 and power down the generator 116. The sensors 122 can also signal to the inverter-charger 112 to flow current from the batteries 110 or other backup power source 102 to the electrical loads 504 of the home 506.

As illustrated in FIG. 2, the power source 102 can include one or more solar panels 208, turbines 218 (wind, steam) and/or other sources for powering the electrical loads 504 during a power outage. The power source 102 can further include one or more power storage devices 220 (e.g., batteries) electrically coupled to, e.g., the solar panels 208 and/or turbines 218 for storing solar energy absorbed by the solar panels 208 or power produced by the turbines 218 for powering the electrical loads 504 during a power outage. With reference to FIG. 3, in some embodiments, the power generated by, e.g., the solar panels 208 and/or turbines 218 can be used to only recharge the batteries 110. For example, the solar panels 208, turbines 218 and/or storage devices 220 can be electrically coupled to the transfer switch 114, inverter-charger 112, batteries 110 and/or generator 116 (e.g., to power the generator 116) to charge the batteries 110 as needed when house current and/or the generator 116 is unavailable. In some embodiments, the solar panels 208, turbines 218 and/or storage devices 220 can be electrically coupled to the transfer switch 114, generator 116, inverter-charger 112 and/or batteries 110 to both charge the batteries 110 and power the electrical loads 504 as needed. In some embodiments, the power generator system 100 does not include a solar panel 208, turbine 218, and/or power storage device 220.

With reference to FIG. 4, the power source 102 (e.g., the batteries 110) can be sealed within the weather proof enclosure 424. The weather proof enclosure 424 is configured to protect the batteries 110 from water, snow, ice, dirt, dust and/or other debris or contaminants. The weather proof enclosure 424 can include a removable door 426 to provide access to the batteries 110 for replacement or repair. The weather proof enclosure 424 can include cabling, plugs, outlets, switches and/or other types of connectors integrated into the enclosure 424 to help prevent connection mistakes (e.g., between the batteries 110 and other components of the power system generator 100) which can reduce or eliminate the potential for physical harm to a user and/or the components. For example, the weather proof enclosure 424 can include “plug and play” capability with the inverter-charger 112 (e.g., such that the enclosure 424 and the batteries 110 can be integrated to an existing home power grid and/or other off-the-shelf products such as an inverter-charger, generator, transfer switch, circuit panel, etc.). In certain embodiments, custom fabricated cables 428 connect and/or run between the batteries 110, inverter-charger 112, transfer switch 114, generator 116 and/or the enclosure 124. In certain embodiments, one of the cables 428 is a “final” cable connection between a “last” battery of the batteries 110 and the inverter-charger 112. If the batteries 110 are for example, a three car battery bank, the final cable 428 may have to handle or contain 200 amps and can be a 00 wire.

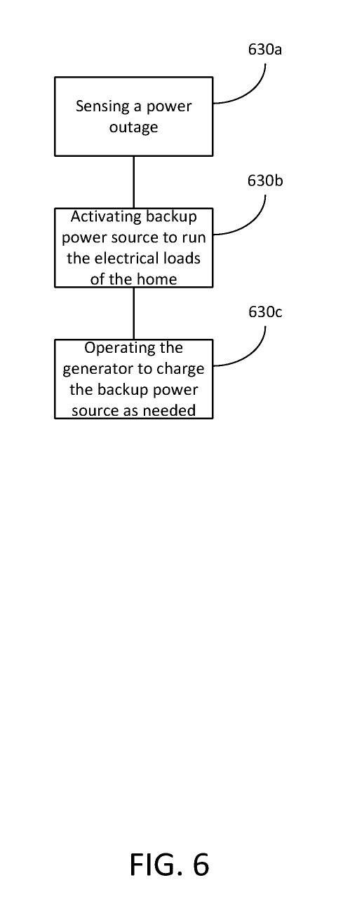

FIG. 6 schematically illustrates a method of operating the power generator system 100 to power the electrical loads 504 of the home 506 in accordance with an embodiment of the present technology. The method can include determining or sensing a power outage (630a). Adjusting or activating electric power for running the electrical loads 504 to be supplied by the backup power source 102, e.g., batteries 110 (630b). The method can include starting the generator 116 to charge the batteries 110 as needed (630c).

In one aspect of the power generator system 100, power from the batteries 110 is used to power the electrical loads 504 of the home 506 during power outages. In certain embodiments, the power generator system 100 is configured to be operated during lower power utilization or consumption times (e.g., evening or nighttime). In such times, the air conditioning may not be running or necessary and less noisy backup power systems may be desirable. In certain embodiments, a power generator system 100 with a minimal amount of battery power may be unable to run, e.g., a refrigerator for an extended period of time. In some embodiments, the power generator system 100 is operated as a “Peaking Unit” (e.g., the batteries 110 are sufficient to start and run electrical loads of an entire house for short periods of time).

Although the foregoing embodiment illustrates one possible use of the power generator system 100 (e.g., coupled to the home 506), those of ordinary skill in the art will appreciate that the power generator system 100 and/or other power generator devices or components disclosed herein can be used in a wide variety of different environments, systems and/or applications. Such systems or applications can include, for example, in renewable energy systems, recreational vehicles (RVs), mobile homes, camping sites, construction sites or other remote locations, office buildings, industrial buildings, hospitals, farms, factories, gas stations, rest stops, schools, and for other emergency or backup applications. The power generator system 100 can be used with different types of power sources, batteries, inverter-chargers, transfer switches and/or generators. For example, the power generator system 100 can be used with solar panels, turbines, other batteries (e.g., car batteries inside an electric car) as the power source and/or for recharging the power source.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/we claim:

1. A power generator system for providing backup power to a household electrical system comprising, an inverter-charger electrically coupled to (a) a battery, (b) a generator and (c) a household electrical panel, wherein the inverter-charger is configured to invert DC power provided by the battery to AC power to be distributed to the household electrical system and the generator is configured to charge the battery.

2. The power generator system of claim 1 wherein the generator is of insufficient size to start or continuously run electrical loads of the household electrical system.

3. The power generator system of claim 1 wherein the generator is not configured to supply power to the household electrical system.

4. The power generator system of claim 1 further comprising a transfer switch configured to allow the battery draw power from the generator or to allow the household electrical system to draw power from the battery.

5. The power generator system of claim 4 wherein the transfer switch is electrically coupled to a main circuit panel, secondary circuit panel or electric outlet of the household electrical system.

6. The power generator system of claim 4 wherein the transfer switch is electrically coupled to the generator.

7. The power generator system of claim 1 further comprising one or more sensors for sensing when the battery requires charging or the household electrical system is experiencing an outage.

8. The power generator system of claim 7 wherein the sensors are electrically coupled to the transfer switch and are configured to signal the transfer switch to activate the generator to charge the battery when the sensor senses that the battery requires charging.

9. The power generator system of claim 7 wherein the sensors are configured to signal the transfer switch to allow current to flow from the household electrical system to charge the battery and to power down the generator when power from the household electrical system is available.
